(19) United States
(12) Patent Application Publication
(10) Pub. No.: US 2020/0375387 A1
(43) Pub. Date: Dec. 3, 2020

(54) Coconut opener

(71) Applicant: DACHA ATSAWACHOKJAROEN, Hubei Province (CN)

(72) Inventor: Li Zhang, Hubei Province (CN)

(21) Appl. No.: 16/656,582

(22) Filed: Oct. 18, 2019

(30) Foreign Application Priority Data
May 31, 2019 (CN) 201910473362.5

(51) Int. Cl. A47J 25/00; B26B 9/02; A23N 5/03

(52) U.S. Cl. CPC A47J 25/00; B25G 1/10; A23N 5/03; B26B 9/02

(57) ABSTRACT

The invention relates to a coconut opener, which comprises a barrel-shaped main body, a blade extending outward from the periphery of the main body and a connecting rod connecting the main body. The main body has an opening end and a tail hole, the diameter of the opening end is larger than the diameter of the tail hole; the blade is connected with the opening end; the connecting rod is installed on one side of the main body. The structure of the coconut opener mentioned above is simple. The coconut shell can be cut with the blade through tapping the main body. The cone part of the coconut can be pierced through the tail hole, and the main body with the cut coconut shell is pulled out from the coconut through the connecting rod, so as to realize the opening of the coconut with high efficiency, easy operation, and no scratch to the operator.

### TECHNICAL FIELD

The invention relates to the field of fruit machinery, in particular to a coconut opener.

### BACKGROUND TECHNOLOGY

Coconut is the fruit of coconut tree. Coconut juice and coconut meat are rich in a lot of protein, fructose, various vitamins and microelement and other nutrients. It is delicious fruits for all ages.

But coconuts are made up of thick fibrous pericarps called exocarps, hard protective endocarps or shells, and fleshy intermediate layers called kernels. If you need to get coconut juice, you need to crack the coconut shell.

In traditional technology, the method of obtaining coconut juice is to gradually cut off the shell of coconut with a knife to form a thinner conical shape at one end of coconut, then cut off the cone part, open a hole, pour out the coconut juice or directly insert it into the straw for drinking. The method mentioned above is difficult to operate, inconvenient, inefficient and difficult to locate. The operator is easily scratched by the knife. If the force is excessive, the coconut will crack, the coconut liquid will flow out, and the impurities in the shell will mix into the coconut liquid and so on.

Invention Content

Based on this, it is necessary to provide a coconut opener with simple operation and high efficiency in view of the existing problems of traditional technology.

In order to realize the purpose, the invention adopts the following technical scheme:

A coconut opener includes a barrel-shaped main body, a blade extending outward from the periphery of the main body and a connecting rod connecting the main body. The main body has an opening end and a tail hole, the diameter of the opening end is larger than the diameter of the tail hole; the blade is connected with the opening end; the connecting rod is installed on one side of the main body.

The structure of the coconut opener mentioned above is simple. The coconut shell is cut with the blade though tapping the main body. The cone part of the coconut can be pierced through the tail hole, and the main body with the cutting coconut shell is pulled out from the coconut through the connecting rod, so as to realize the coconut opening with high efficiency and easy operation, no scratch to the operator.

In one of the embodiments, the opening end is provided with an arc-shaped notch near one side of the connecting rod.

In one of the embodiments, the radius of the arc-shaped notch is less than the radius of the main body, and the radius of the arc-shaped notch is larger than the diameter of the connecting rod.

In one of the embodiments, a reinforcing ring is arranged at one end of the main body near the tail hole, and the thickness of the reinforcing ring is greater than that of the main body side wall.

In one of the embodiments, the cross section of the blade is arranged in a triangular shape.

In one of the embodiments, the blade face towards the inner wall of the main body is a flat surface, and the blade back to the inner wall of the main body is a blade face.

In one of the embodiments, the angle between the blade surface and the flat surface is an acute angle.

In one of the embodiments, the angle between the blade surface and the flat surface ranges from 5 degrees to 70 degrees.

In one of the embodiments, one side of the blade facing the inner wall of the main body is an inner blade surface, the other side of the blade back to the inner wall of the main body is an outer blade surface, and the inner blade surface is matched with the outer blade surface for cutting.

In one of the embodiments, the connecting rod is provided with a rubber sleeve.

### DRAWING DESCRIPTION

FIG. 1 is a three-dimensional schematic diagram of a coconut opener in a better embodiment of the present invention.

FIG. 2 is an enlarged view of A as shown in FIG. 1.

FIG. 3 is the top view of the coconut opener as shown in FIG. 1.

FIG. 4 is a side view of the coconut opener as shown in FIG. 1.

### SPECIFIC IMPLEMENTATION MODE

In order to facilitate understanding of the present invention, a more comprehensive description of the present invention will be given below with reference to the relevant drawings. Better embodiments of the present invention are shown in the drawings. However, the present invention can be implemented in many different forms and is not limited to the embodiments described herein. Conversely, the purpose of providing these embodiments is to provide a more thorough and comprehensive understanding of the disclosure of the invention.

It should be noted that when a component is referred to as “fixed” to another component, it can be directly on another component or can also exist in the centered component. When a component is considered to be “connected” to another component, it can be directly connected to another component or may have a centralized component at the same time.

Unless otherwise defined, all technical and scientific terms used herein have the same meaning as those commonly understood by technicians in the technical field of the present invention. The terms used in the specification of the invention herein are for the purpose of describing specific embodiments only, not to limit the invention.

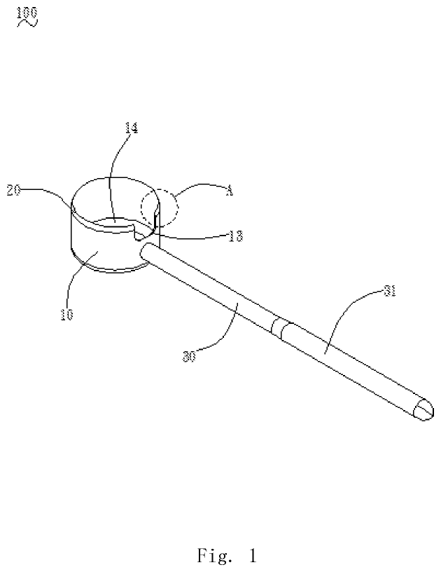

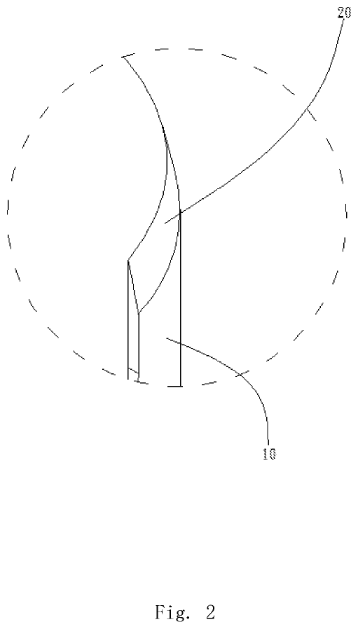

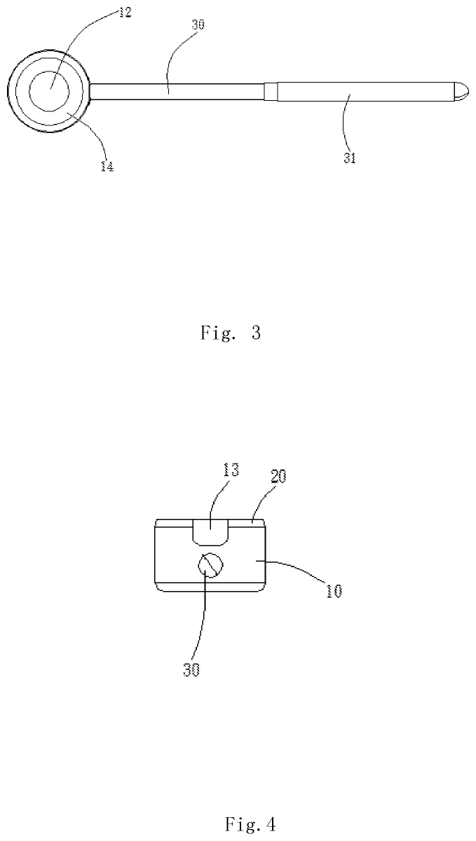

Referring to FIGS. 1 to 4, the coconut opener 100 for a better embodiment of the present invention is used for opening coconut. The coconut opener 100 can be fitted with hammers, rods or mounted on a coconut shell opener to open coconut holes. The coconut opener 100 comprises a main body 10, a blade part 20 extending outward from the periphery of the autonomous body 10 and a connecting rod 30 connecting the main body 10. When in use, the coconut opener 100 can be placed on the top of the coconut, holding the connecting rod 30 with your hand, tapping the main body 10 with a hammer, so that the blade 20 can cut the coconut slowly, and then through the connecting rod 30, the main body 10 with the cut coconut shell can be pulled out from the coconut to complete the opening in the coconut.

The main body 10 is roughly barrel-shaped. The diameter of the end of the main body 10 is equal to the diameter of the tail. During the tapping process, the coconut shell can be uniformly stressed. Understandably, in other embodiments, body 10 may also be triangular, conical, etc. The main body 10 has an opening end and a tail hole 12 to match the cone setting of the top of the coconut. The diameter of the opening end is larger than the diameter of the tail hole 12, so that the cone part of the coconut can pierce through the tail hole 12 during the tapping process. Optionally, an arc-shaped notch 13 is arranged on the side of the opening end near the connecting rod 30, and the radius of the arc notch 13 is smaller than the radius of the main body 10, and the radius of the arc notch 13 is also greater than the diameter of connecting rod 30, the bottom of the arc notch 13 is connected with the surface of the coconut, to not to cut the coconut. It can not only retain the shell of the cutting coconut hole, and partly connect with the coconut shell, thus avoiding the cutting coconut shell falls into the coconut, but also controlling the tapping strength, avoiding excessive knocking on the coconut shell and causing the coconut shell to crack. Optionally, a reinforcing ring 14 is arranged at one end of the main body 10 near the tail hole 12, and the thickness of the reinforcing ring 14 is greater than that of the side wall of the main body 10, so as to strengthen the tail end of the main body 10.

The blade part 20 is connected with the opening end, and is triangular shape when viewed from the outside or from the cross section. Specifically, the one side of the blade part 20 facing the inner wall of the main body 10 is a flat surface, and the one side of the blade part 20 back to the inner wall of the main body 10 is a blade surface. In one of the embodiments, the angle between the blade surface and the flat surface is an acute angle; the angle between the blade surface and the flat surface ranges from 5° to 70°; and preferably, the angle between the blade surface and the flat surface ranges from 10° to 30°. Understandably, in other embodiments, one side of the blade part 20 facing the inner wall of the main body 10 is the inner blade face, the other side of the blade part 20 back to the inner wall of the main body 10 is the outer blade face, and the inner blade face matches the outer blade face for cutting.

The connecting rod 30 is installed on one side of the main body 10. The length of the connecting rod 30 is larger than the diameter of the main body 10. The lever principle is used to reduce the user's pulling out force. In one embodiment, when the connecting rod 30 is a handle, a rubber sleeve 31 is sleeved on the handle. Understandably, in other embodiments, when the connecting rod 30 is installed on the machine, the connecting rod 30 is provided with a connecting part to facilitate the connection between the connecting rod 30 and the machine.

In another embodiment, the main body 10 and the connecting rod 30 are made of stainless steel.

The structure of the coconut opener 100 is simple. By tapping the main body 10 and cutting the coconut shell with blade 20, the coconut cone can be pierced out of the tail hole 12, and the main body 10 with the cutting coconut shell can be pulled out from the coconut through the connecting rod 30 to achieve the opening of the coconut, with high efficiency, easy operation and no scratch to the operator.

The technical features of the above-mentioned embodiments may be arbitrarily combined. For the simplicity of description, all possible combinations of the technical features in the above-mentioned embodiments are not described. However, as long as there is no contradiction between the combinations of these technical features, it should be considered as the scope of the present specification.

The above-mentioned embodiments only express several embodiments of the invention, which are described in more specific and detail, but can't be understood as restrictions on the scope of invention patents. It should be noted that for ordinary technicians in the field, a number of modifications and improvements can be made without departing from the concept of the present invention, which belong to the scope of protection of the present invention. Therefore, the scope of protection of the invention patent shall be subject to the appended claims.

1. A coconut opener, it is characterized by a barrel-shaped main body, a blade extending outward from the periphery of the main body and a connecting rod connecting the main body. The main body has an opening end and a tail hole, the diameter of the opening end is larger than the diameter of the tail hole; the blade is connected with the opening end; the connecting rod is installed on one side of the main body.

2. The coconut opener described in the claim 1, it is characterized in that an arc-shaped notch is arranged on the side of the opening end near the connecting rod.

3. The coconut opener described in the claim 2, it is characterized in that the radius of the arc-shaped notch is less than the radius of the main body, and the radius of the arc-shaped notch is larger than the diameter of the connecting rod.

4. The coconut opener described in the claim 1, it is characterized in that a reinforcing ring is arranged at one end of the main body near the tail hole, and the thickness of the reinforcing ring is greater than the thickness of the main body side wall.

5. The coconut opener described in the claim 1, it is characterized in that the cross section of the blade is arranged in a triangle shape.

6. The coconut opener described in the claim 5, it is characterized in that the one side of the blade facing the inner wall of the main body is a flat surface, and the one side of the blade back to the inner wall of the main body is a blade surface.

7. The coconut opener described in the claim 6, it is characterized in that the angle formed by the blade surface and the flat surface is an acute angle.

8. The coconut opener described in the claim 7, it is characterized in that the angle between the blade surface and the flat surface ranges from 5° to 70°.

9. The coconut opener described in the claim 5, it is characterized in that one side of the blade facing the inner wall of the main body is an inner blade surface, the one side of the blade back to the inner wall of the main body is an outer blade surface, and the inner blade surface matches the outer blade surface for cutting.

10. The coconut opener described in the claim 1, it is characterized in that the connecting rod is provided with a rubber sleeve.
